(19) United States
(12) Patent Application Publication
(10) Pub. No.: US 2006/0238463 A1
(43) Pub. Date: Oct. 26, 2006

(54) Electro luminescence display device

(75) Inventors: Woochan Kim, Youngtong-Gu (KR); Jong Geun Yoon, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/402,865

(22) Filed: Apr. 13, 2006

(30) Foreign Application Priority Data
Apr. 26, 2005 (KR) 10-2005-0034752
Jul. 5, 2005 (KR) 10-2005-0060495

(51) Int. Cl. G09G 3/30

(52) U.S. Cl. 345/80

(57) ABSTRACT

The present invention provides electro luminescence display devices comprising a pixel circuit comprising a pixel circuit comprising a plurality of pixels on a substrate; a data driver formed on one side of the pixel circuit for supplying a data signal to the plurality of pixels; at least one scan driver formed on at least one side of the pixel circuit for supplying a scan signal to the plurality of pixels; and a plurality of wirings connected to an outer circuit, wherein at least one of the plurality of wings is formed on a portion of perimeter of one or more of the data driver, the pixel circuit or the substrate.

This Non-provisional application claims priority under 35 U.S.C. § 119(a) on Patent Application No. 10-2005-34752 filed in Korea on Apr. 26, 2005 and Application No. 10-2005-60495 filed in Korea on Jul. 5, 2005, the entire contents of which are hereby incorporated by reference.

### BACKGROUND OF THE INVENTION

1. Field of the Invention

The present invention generally relates to electro luminescence (hereinafter, EL) display devices.

2. Description of the Related Art

An organic EL display device, which utilizes an organic electro luminescent element to emit light by recombination of electrons and holes, has a shorter response time than a passive type display device such as a liquid crystal display (hereinafter, LCD) that requires a separate light source. Furthermore, since an organic EL display device can be driven by low voltage direct current and be manufactured as a thin film, it can be applied to a wall-type display or a portable display.

FIG. 1a is a plane view showing internal construction of a conventional organic EL display device and FIG. 1b is a cross-sectional view along line A-A′ of FIG. 1a. For convenience of explanation, FIGS. 1a and 1b have been illustrated without a protective plate over the display device.

The organic EL display device 10 comprises a pixel circuit 12, which is installed on a substrate 11 and displays images, while a plurality of RGB pixels P is formed within the pixel circuit 12. For convenience of explanation, FIG. 1a illustrates only one pixel.

A data driver 13 connected to data line D of each pixel P, is formed at an outer side of the pixel circuit 12 corresponding to an outer circuit 15, and enables data signals to be transmitted to pixels Ps.

A first scan driver 14a connected to scan lines S of some pixels is located at one side of the pixel circuit 12, while a second driver 14b connected to scan lines S of the other pixels is located at the other side of pixel circuit 12, and enables scan signals to be transmitted to pixels Ps. As the first driver 14a and the second driver 14b are connected electrically to the outer circuit 15, the pixels P can be driven by electrical signals from the outer circuit 15.

Outer surfaces of the pixel circuit 12, of data driver 13, of first scan driver 14a, and of second scan driver 14b, are treated with sealant 18 to allow a protective plate be attached on the substrate 11, so that all the components including pixels Ps can be isolated from the outside and be protected from impurities such as humidity, oxygen, etc.

A power supply line (hereinafter, VDD) 16 is located on the substrate 11 between the first scan driver 14a and the pixel circuit 12, and a ground line (hereinafter, GND) 17 is located on the substrate 11 between the second scan driver 14b and the pixel circuit 12, whereby the VDD 16 and the GND 17 are connected to the outer circuit 15.

Referring to FIGS. 1a and 1b, the areas between vertical hemlines of the pixel circuit 12 and terminals of the substrate 11 are called Bezel areas B1 and B2. The Bezel areas B1, B2, in which no image can be displayed, function as a factor for enlarging the size of an organic EL display device. In a conventional organic EL display device, a display device with a bigger Bezel area needs to be larger-sized than one with a smaller Bezel area, even when the two display devices have a same-sized pixel circuit. In this case, sizes of the main window and the sub-window of a mobile communication terminal adopting such an organic EL display device need to be bigger as well. Moreover, the Bezel areas create, in the main window and in the sub-window of the mobile communication terminal, a considerable size of dead spaces where no image can be displayed.

Although the protective plate on the display device has been omitted in the above drawings for the convenience of this discussion, in the conventional art, one W1 of curing margins are provided between sealants 18 and the first scan driver 14a. Simultaneously, the other W2 of curing margins are provided between sealants 18 and the first scan driver 14b.

These curing margins W1 and W2 protect the scan drivers 14a and 14b from unexpected damage when the protective plate is adhered on the substrate by sealant 18 in the process of optical and/or heat curing. For example, a positioning error can occur due to various factors in the course of optical curing after a prescribed thickness of the sealant 18 has been sprayed on the substrate 11. A positioning error allows UV rays to cause damage to the first scan driver 14a and the second scan driver 14b. Also, when main circuits such as scan drivers 14a and 14b are damaged, noise can be generated in the circuit.

Accordingly, when the size of the curing margins increase, the size of the Bezel areas increases resulting in a decreasing probability of an error. However, increasing curing margins also increases the number of dead spaces where no images can be displayed.

### SUMMARY OF THE INVENTION

Accordingly, the present invention is to solve at least the problems and disadvantages of the related art.

The aspect of the present invention is electro luminescence display devices that can minimize the Bezel area through effective alignment of components thereof.

An EL display device in accordance with the present invention comprises a pixel circuit comprising a pixel circuit comprising a plurality of pixels on a substrate; a data driver formed on one side of the pixel circuit for supplying a data signal to the plurality of pixels; at least one scan driver formed on at least one side of the pixel circuit for supplying a scan signal to the plurality of pixels; and a plurality of wirings connected to an outer circuit, wherein at least one of the plurality of wings is formed on a portion of perimeter of one or more of the data driver, the pixel circuit or the substrate.

Also, the scan driver can be located on one side of the pixel circuit together with one side of the data driver, and the plurality of wirings can be formed on a portion of perimeter of the pixel circuit and the scan driver.

Also, the scan driver can be located on one side of the pixel circuit on the opposite side of the data driver, and the plurality of wiring can be formed on a portion of perimeter of the pixel circuit and the data driver.

Also, the scan driver can be located on one sides of the pixel circuit, and one or more of the plurality of wirings can be located on a portion of perimeter of at lease one of the data driver or the substrate.

### BRIEF DESCRIPTION OF THE DRAWINGS

The invention will be described in detail with reference to the following drawings in which like numerals refer to like elements.

FIG. 1a is a plane view showing internal construction of a conventional organic EL display device.

FIG. 1b is a cross-sectional view along line A-A′ of FIG. 1a.

FIG. 2a is a plane view showing internal construction of an organic EL display device in accordance with a first embodiment example of the present invention.

FIG. 2b is a cross-sectional view along line Z-Z′ of FIG. 2a.

FIG. 3 is a plane view showing internal construction of an organic EL display device in accordance with a second embodiment example of the present invention.

FIG. 4 is a plane view showing internal construction of an organic EL display device in accordance with a third embodiment example of the present invention.

FIG. 5 is a plane view showing internal construction of an organic EL display device in accordance with a fourth embodiment example of the present invention.

FIG. 6 is a plane view showing internal construction of an organic EL display device in accordance with a fifth embodiment example of the present invention.

### DETAILED DESCRIPTION OF PREFERRED EMBODIMENTS

Preferred embodiments of the present invention will be described in a more detailed manner with reference to the drawings.

### First Embodiment

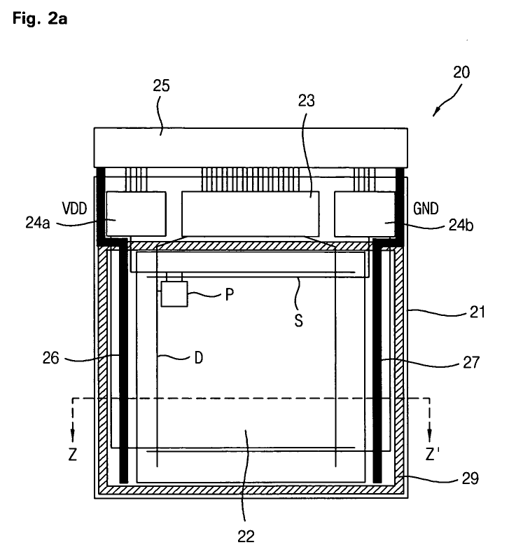

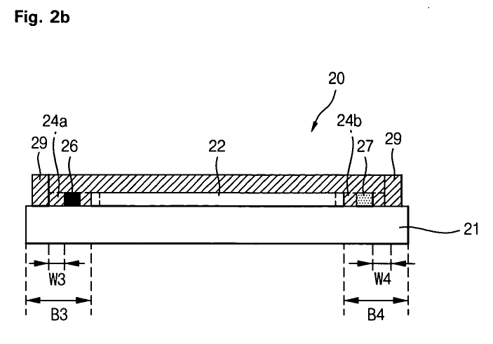

FIG. 2a is a plane view showing internal construction of an organic EL display device in accordance with a first embodiment example of the present invention, and FIG. 2b is a cross-sectional view along line Z-Z′ of FIG. 2a.

As shown in the drawings, an EL display device 20 as per the present invention comprises an pixel circuit 22 formed on a substrate 21 for displaying images, whereby the pixel circuit 22 includes a plurality of RGB pixels. In addition, a data driver 23 connected to data lines D of the pixels P is formed at one side of the pixel circuit 22, i.e. at an area adjacent to an outer circuit 25 for supplying data signals to the pixels P.

Adjacent to the pixel circuit 22, a first scan driver 24a connected to scan line S of the pixels P is formed at one side of the data driver 23, and a second scan driver 24b connected to scan line S of the pixels P is formed at the other side of the data driver 23, whereby the data driver 23, the first scan driver 24a, and the second scan driver 24b are electrically connected to the outer circuit 25. As a result, the pixels P can be driven by the first and the second scan drivers 24a, 24b upon receiving signals from the outer circuit 25.

Power lines connected to the outer circuit 25, i.e. a power supply line 26 and a ground line 27 are installed at outer side of the first scan driver 24a and of the second scan driver 24b from the pixel circuit 22, respectively. There is a sealant 29 on the fringe of them which seals the pixel circuit 22 from impurities such as water and oxygen.

However, the above allocation of the power supply line 26 and the ground line 27 is only an example from an embodiment of the present invention. The locations of the power supply line 26 and the ground line 27 can vary dependant on the designs. Here, it is important the power supply line 26 and the ground line 27 are placed at outer sides of the first and the second scan drivers 26, 27. As a result, provision of curing margins W3, W4 becomes minimized or unnecessary, as the first and the second scan drivers 24a, 24b are placed sufficiently inwardly and are protected from ultra violet rays.

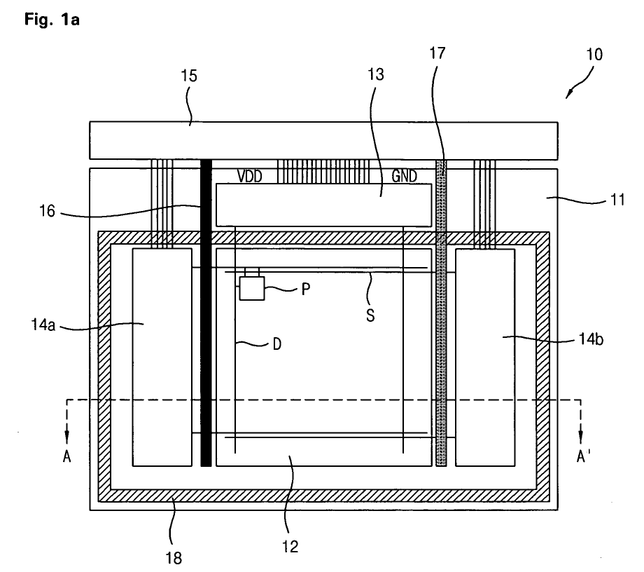

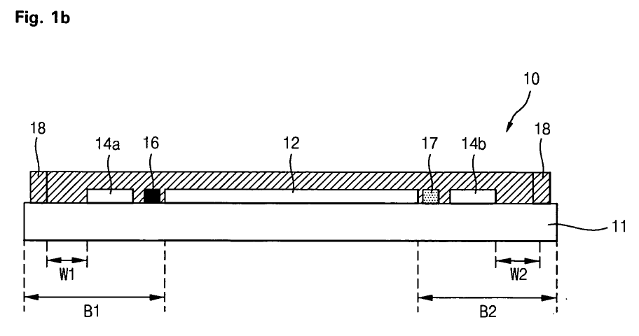

By installing the first scan driver 24a and the second scan driver 24b at both sides of the data driver 23 as shown in FIGS. 2a and 2b, and not at both sides of the pixel circuit 22 as in FIG. 1, the Bezel areas B1, B2 formed between terminals of the substrate 21 and terminals of the pixel circuit 22 can substantially be reduced. Accordingly, a compact EL display device with a minimal size of Bezel area can be manufactured by optimizing positions of the data driver and the scan drivers.

Other embodiments of the present invention, of which a description follows below, have been generated by varying positions of the components, wherein like numerals refer to like elements. In the following description, only an explanation on positional differences of the components with direct relevancy to the present invention such as the first scan driver, the second scan driver, the power supply line (hereinafter, VDD), and the ground line (hereinafter, GND) is given, and explanation on functions of such components as well as explanation on other components are omitted.

### Second Embodiment

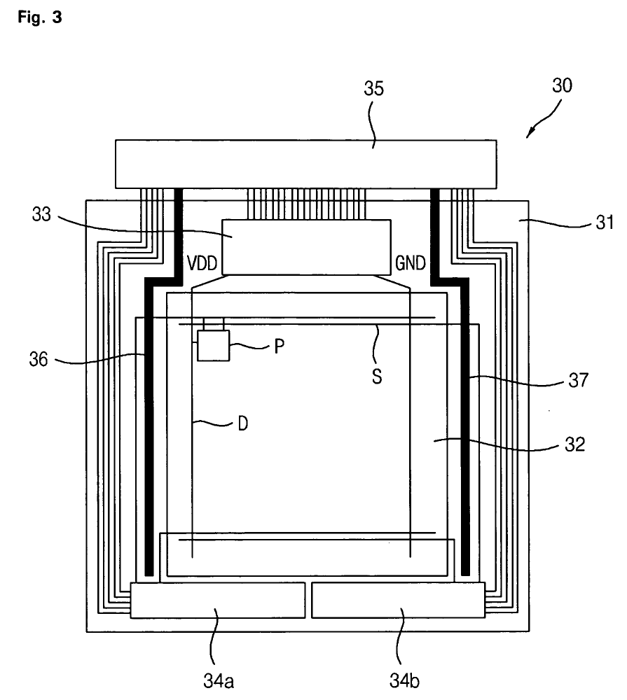

FIG. 3 is a plane view showing internal construction of an organic EL display device in accordance with a second embodiment example of the present invention.

As a preliminary the drawings of the present invention show a display device in a state the protective plate has been removed and depict the components in a schematic manner. Accordingly, sealant to be applied on outer sides of the pixel circuit 32, the data driver 33, the first scan driver 34a, and the second scan driver 34b, as well as a protective plate to be affixed on the substrate 31 by sealant are not illustrated.

As shown in FIG. 3, positions of the first scan driver 34a and of the second scan driver 34b on the organic EL display device 30, as they are on a non-emitting area, differ from the forming positions of the first scan driver 24a and the second scan driver 24b in FIG. 2a.

As the first scan driver 34a and the second scan driver 34b are located on each side of the pixel circuit 32 on the opposite side of the data driver 33, so the size of Bezel areas formed by spaces between both ends of the pixel circuit 32 and of the substrate 31 are reduced substantially.

### Third Embodiment

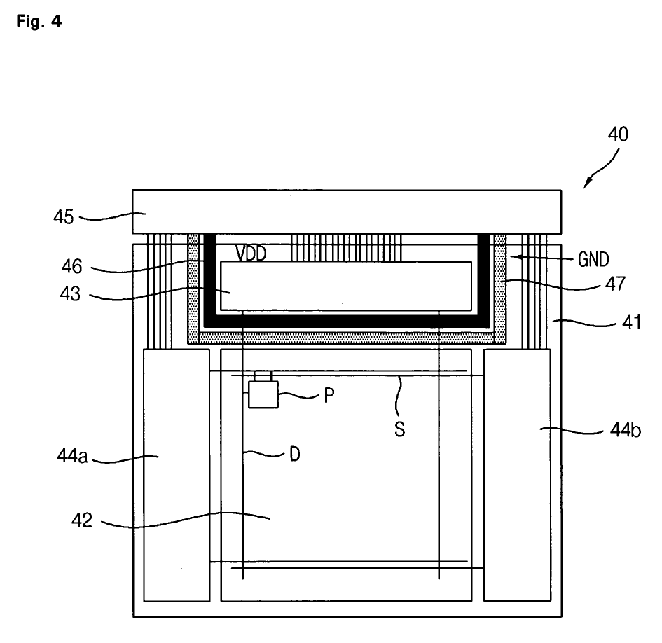

FIG. 4 is a plane view showing internal construction of an organic EL display device in accordance with a third embodiment example of the present invention.

As a preliminary, the drawings of the present invention show a display device in a state the protecting plate has been removed and depict the components in a schematic manner. Accordingly, sealant to be applied on outer sides of the pixel circuit 42, the data driver 43, the first scan driver 44a, and the second scan driver 44b, as well as a protective plate to be affixed on the substrate 41 by sealant are not illustrated.

As shown in FIG. 4, a data driver 43 is formed atone side of the pixel circuit 42, while a first scan driver 44a and a second scan driver 44b are formed at other sides of the pixel circuit 42, respectively, on an organic EL display device 40.

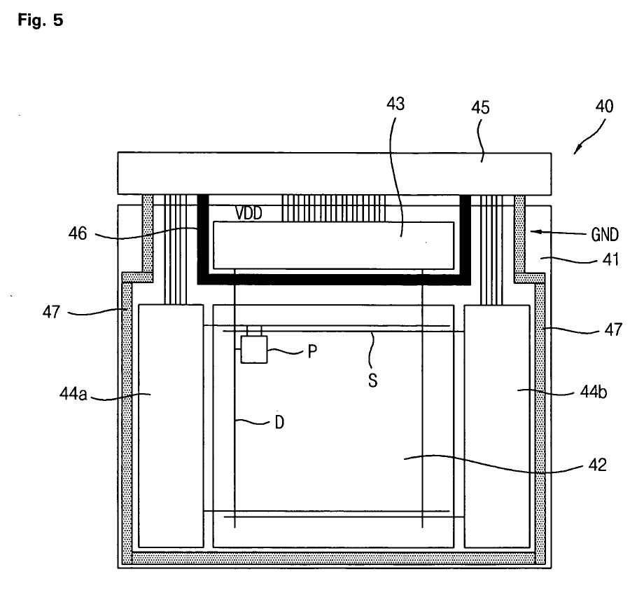

Both a VDD 46 and a GND 47 are formed between the data driver 43 and the pixel circuit 42 along rim of the data driver 43 as shown in FIG. 5. By not installing the VDD 46 and the GND 47 at both sides of the pixel circuit 42, the size of Bezel areas are reduced substantially.

### Fourth Embodiment

FIG. 5 is a plane view showing internal construction of an organic EL display device in accordance with a fourth embodiment example of the present invention.

As shown in FIG. 5, arrangements of the pixel circuit 42, data driver 43, the first scan driver 44a, and the second scan driver 44b on the organic EL display device 40 are the same as in the second embodiment example.

A VDD 46 is formed between the data driver 43 and the pixel circuit 42, and a GND 47 is formed along outer rim of the substrate 41 as shown in FIG. 5. By not installing the VDD 46 and the GND 47 at both sides of the pixel circuit 42, the size of Bezel areas are reduced substantially.

### Fifth Embodiment

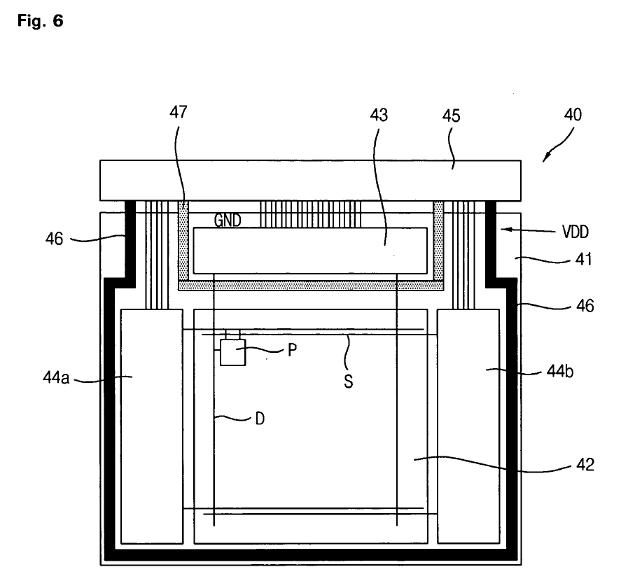

FIG. 6 is a plane view showing internal construction of an organic EL display device in accordance with a fifth embodiment example of the present invention.

As a preliminary, the drawings of the present invention show a display device in a state the protecting plate has been removed and depict the components in a schematic manner. Accordingly, sealant to be applied on outer sides of the pixel circuit 42, the data driver 43, the first scan driver 44a, and the second scan driver 44b, as well as a protective plate to be affixed on the substrate 41 by sealant are not illustrated.

As shown in FIG. 6, a GND 47 is formed between the data driver 43 and the pixel circuit 42, and a VDD 46 is formed along outer rim of the substrate 41 as shown in FIG. 5. By not installing the VDD 46 and the GND 47 at both sides of the pixel circuit 42, the size of Bezel areas are reduced substantially.

Although the above embodiments of the present invention have been described to comprise one data driver each the present invention is not limited thereto, but rather can adopt a plurality of data driver as well

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electro luminescence display device comprising:
a pixel circuit comprising a plurality of pixels on a substrate;
a data driver formed on one side of the pixel circuit for supplying a data signal to the plurality of pixels;
at least one scan driver formed on at least one side of the pixel circuit for supplying a scan signal to the plurality of pixels; and
a plurality of wirings connected to an outer circuit, wherein at least one of the plurality of wings is formed on a portion of perimeter of one or more of the data driver, the pixel circuit or the substrate.

2. The electro luminescence display device as set forth in claim 1, wherein the scan driver is located on one side of the pixel circuit together with one side of the data driver, and the plurality of wirings are formed on a portion of perimeter of the pixel circuit and the scan driver.

3. The electro luminescence display device as set forth in claim 2, wherein the pixel circuit of the electro luminescence display device comprises an organic luminescence layer.

4. The electro luminescence display device as set forth in claim 3, wherein there are two or more scan drivers that are located on both sides of the data driver.

5. The electro luminescence display device as set forth in claim 3, wherein the plurality of wirings are ground line GND and power supply line VDD that are located on the outer side of the scan drivers.

6. The electro luminescence display device as set forth in claim 1, wherein the scan driver is located on one side of the pixel circuit on the opposite side of the data driver, and the plurality of wiring are formed on a portion of perimeter of the pixel circuit and the data driver.

7. The electro luminescence display device as set forth in claim 6, wherein the pixel circuit of the electro luminescence display device comprises an organic luminescence layer.

8. The electro luminescence display device as set forth in claim 7, wherein there are two or more scan drivers that are located parallel to each other.

9. The electro luminescence display device as set forth in claim 7, wherein the plurality of wirings comprise GND and VDD that are formed between wirings connected to the pixel circuit and the scan driver.

10. The electro luminescence display device as set forth in claim 1, wherein the scan driver is located on one sides of the pixel circuit, and one or more of the plurality of wirings are located on a portion of perimeter of at lease one of the data driver or the substrate.

11. The electro luminescence display device as set forth in claim 10, wherein the pixel circuit of the electro luminescence display device comprises an organic luminescence layer.

12. The electro luminescence display device as set forth in claim 11, wherein there are two or more scan drivers that are located on both sides of the pixel circuit.

13. The electro luminescence display device as set forth in claim 11, wherein the plurality of wirings are GND and VDD that are formed on a portion of perimeter of the data driver between the pixel circuit and the data driver.

14. The electro luminescence display device as set forth in claim 11, wherein the plurality of wirings are GND and VDD where the VDD is formed on a portion of perimeter of the data driver between the data driver and the pixel circuit and the GND is formed on a portion of perimeter of the substrate.

15. The electro luminescence display device as set forth in claim 11, wherein the plurality of wirings are GND and VDD where the GND is formed on a portion of perimeter of the data driver between the data driver and the pixel circuit and the VDD is formed on a portion of perimeter of the substrate.

16. The electro luminescence display device as set forth in claim 11, wherein there are two or more scan drivers that are located on both sides of the data driver.
